(19) United States
(12) Patent Application Publication
(10) Pub. No.: US 2002/0018705 A1
(43) Pub. Date: Feb. 14, 2002

(54) Automatic warehouse

(75) Inventor: Masatomi Kawaguchi, Kagamigahara-shi (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(73) Assignee: Murata Kikai Kabushiki Kaisha, Kyoto-shi (JP)

(21) Appl. No.: 09/880,866

(22) Filed: Jun. 15, 2001

(30) Foreign Application Priority Data
Aug. 11, 2000 (JP) 2000-243742

(51) Int. Cl. B65G 1/137

(52) U.S. Cl. 414/274

(57) ABSTRACT

A hoisting table 31 of a stacker crane 4 in an automated is provided with two units of bar code readers 36,37 for a long distance and a short distance, and an article 20 in a rack is attached with bar codes on the front face and the side face, The bar code reader for a long distance 36 reads bar codes of articles in the rack, and the bar code reader for a short distance 37 reads bar codes of articles loaded on the stacker crane. It is possible to reduce the number of the bar code and make an inventory without taking articles out of the station.

### FIELD OF THE INVENTION

The present invention relates to an automatic warehouse and more particularly to an ID code reader for storing/retrieving articles and articles in stock.

### BACKGROUND OF THE INVENTION

In an automatic warehouse, an ID reader such as a bar code reader is provided at a storing/retrieving station in order to read an ID code such as the bar code attached to articles stored or retrieved. Thus, articles can be checked by reading the bar code when storing. Likewise, when retrieving, it is possible to check whether articles ordered to be retrieved is retrieved or not.

In the case of that the number of station is small, there is no problem stems from providing every station with a bar code reader, however, when providing large numbers of stations, it becomes necessary to have large numbers of the bar code reader. Moreover, an article check can not be done unless articles are conveyed to the station, and in the case of making use of the bar code for checking articles in stock for an inventory etc., there is a necessity to convey articles to the station one by one.

It is the fundamental object of the present invention to reduce the number of an ID code reader necessary for an automatic warehouse, enable to read an ID code of articles stored in a rack without conveying to the station, and enable to read the ID code without fail.

It is a further object of the present invention to enable to read the ID code of articles stored in the rack and back up to read the ID code without fail, in the case that the articles in the rack is failed to be read the ID code.

### SUMMARY OF THE INVENTION

The present invention is an automatic warehouse provided with a conveyer which travels without restraint to convey an article, wherein the conveyer is installed with a hoisting table which moves up and down along a mast, and the hoisting table is installed with an ID reader to read an ID code of articles. A plurality of the ID code are attached to different faces of the article, and a plurality of the ID reader are installed on the hoisting table to correspond to the plurality of the ID code.

Preferably, the ID codes are attached to a front face of the article and another face of the article, and the hoisting table is provided with an ID reader for a long distance to read the ID code attached to the front face of the article and an ID reader for a short distance to read the ID code attached to another face of the article which is held with a transfer equipment.

### BRIEF DESCRIPTION OF THE DRAWINGS

FIG. 1 is a plan view showing an automatic warehouse in an embodiment.

FIG. 2 is a perspective view showing an article attached with bar codes.

FIG. 3 is a plan view showing a stacker crane equipped with a bar code reader is transferring articles between racks.

FIG. 4 is a elevational view showing a stacker crane holding an article.

### DETAILED DESCRIPTION OF THE PREFERRED EMBODIMENTS

In accordance with the present invention, an ID reader to read an ID code of articles is installed on the hoisting table of a conveyer such as a stacker crane, therefore, a small number of the ID reader is sufficient, in the case that a plurality of stations are installed in the automatic warehouse. The ID reader is installed on the hoisting table of a conveyer, so the ID code can be read without conveying articles to the station one by one. A bar code is used as the ID code, and a bar code reader is used as the ID reader, however, it is acceptable to use a code listed an ID code which identifies articles and a reader to read the code.

Moreover, the ID code may be attached to a container or a pallet for articles besides attaching to the article directly, however, the ID code is attached to the article, including all these cases in this specification.

Furthermore, while a plurality of the ID code are attached to another face of the article, a plurality of the ID reader are installed corresponding to respective faces of the article attached with the ID code. Thus, it is possible to read the other ID code with the other ID code reader and read the ID code of articles without fail, even if the ID code is failed to be read because of the ID code in an abnormal condition, came off, stained etc. Therefore, when the ID of the article handling in the automated warehouse is lost, it saves the trouble to convey the article to the station and identify it manually.

Moreover, the ID codes are attached on the front face of the article and another face such as side, top, or bottom face, and the hoisting table is equipped with a bar code reader for a long distance to read the ID code attached to the front face of the article and a bar code reader for a short distance to read the ID code attached to the face other than the front face of the article in a state that the articles is held with the transfer equipment of the hoisting table. As the ID reader for a long distance has an ability to read the ID code attached on the front face of the articles in the rack as it is, an inventory or confirmation of stored articles can be carried out effectively. It reads the ID code on the front face of the article, so that it will never read the ID code for the other articles by mistake.

Furthermore, in the case that the ID code on the front face of the article is failed to be read for some reason or other, it is possible to take out the article with the transfer equipment and read with the ID reader for a short distance.

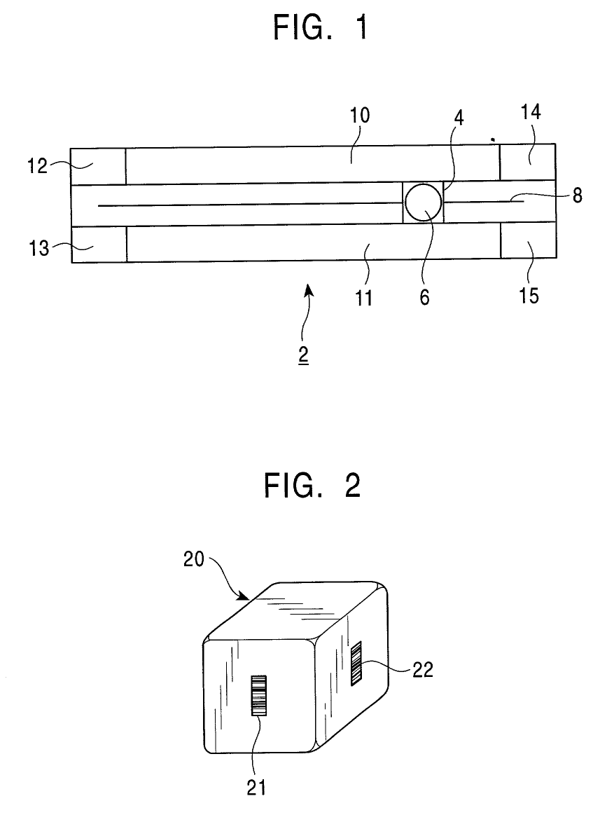

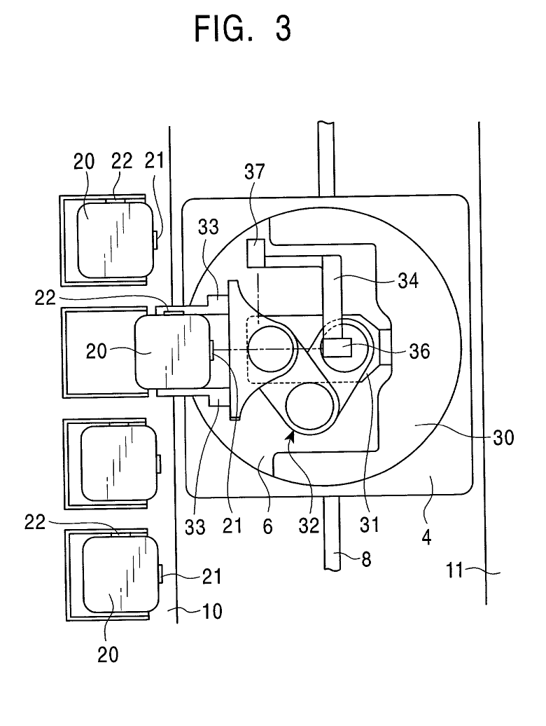

FIGS. 1 to 4 show an embodiment. In FIGS. 1 to 4, 2 is an automatic warehouse, for example, one unit of a stacker crane 4 is equipped as a conveyer, 6 is a turntable thereof, and 8 is a rail. For instance, a pair of racks 10,11 are provided on both sides of the rail 8, and stations 12 to 15 for storing or retrieving are provided at four places. Conventionally, respective stations 12 to 15 have respective bar code readers, therefore, four units of bar code readers are necessary. In the meantime, in the embodiment, two units of bar code readers for a long distance and a short distance are provided on a hoisting table of the stacker crane 4.

A bar code 21 stated an article ID is attached on the front face of an article 20, and a bar code 22 stated the same ID is attached to the side face. The bar code 22 is to be attached only to one of the side face, however, it is also acceptable to attach the bar code 22 having the same contents to the both side faces. It is essential to choose the face for attaching this bar code 22 not to have a plurality of bar codes within the range of detection of the bar code reader at the same time. The stacker crane 4 is provided with a mast 30 on the turntable 6 in order to make hoisting table 31 move up and down along the mast 30. The mast 30 is in a hollow-cylinder-shape, and a driving section (not shown in the drawings) of a hoisting table 31 is placed in this cylinder. The reason why the turntable 6 is provided here is to transfer articles in the 360 degrees direction, all round the stacker crane 4, therefore the turntable 6 is not necessary to be installed. The stacker crane 4 in the embodiment is for a clean room; and the mast 30 is provided with a slit (not shown in the drawings) in a vertical direction for a joint section of the hoisting table 31 and the driving section to move up and down, and the slit is covered with a movable shutter (not shown in the drawings). Air round the hoisting table 31 is sucked from the mast 30 via the turntable 6 and exhausted from the vehicle of the stacker crane 4 to the under floor of the clean room.

The hoisting table 31 is equipped with the scalar arm 32 as the transfer equipment, and a hand 33 of the end is made to open or close to hold an article 20. It is acceptable to use a slide fork etc. as the transfer equipment besides the scalar arm 32, in addition to holding the both sides of the article 20 with the hand 33, the hand 33 can be used to support the bottom face of the article or hold the top part of the article. In the automatic warehouse 2 in the clean room, it is difficult to identify an ID of the article 20 manually. As a consequence of an unsuccessful attempt to read the bar codes 21,22, the process is interrupted because of the article which is failed to be sent to the next process, or the occurrence of unidentified articles in the racks 10,11 creates the need for identifying manually. Therefore, it is necessary to make sure the bar codes 21,22 are read.

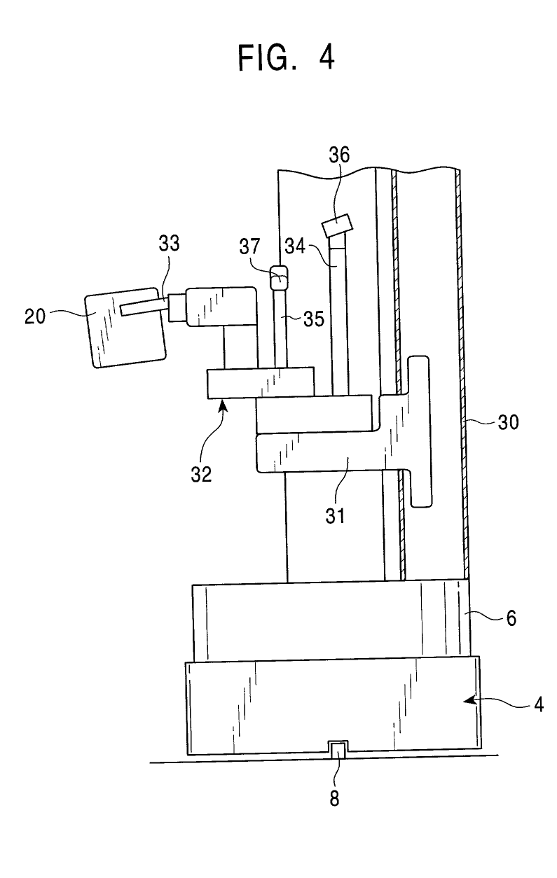

The hoisting table 31 is provided with a bracket 34 and bracket 35 as shown in FIG. 4, and the upper section of the bracket 34 is bent to right above the hoisting table 31 (the upper section of the base of the scalar arm 32) to mount the bar code reader for a long distance 36. The top section of the bracket 35 is placed at the upper section on the side face of the hoisting table 31 in order to read the bar code 22 on the side face of the article 20 which is taken out with the hand 33 to the top section of the hoisting table 31. More specifically, the bar code 21 of the article in the racks 10,11 is read with the bar code reader for a long distance 36 on the spot, and the bar code 22 on the side face of the article taken out to the top of the hoisting table 31 is read with the bar code reader for a short distance 37.

The operation in the embodiment will now be explained.

The stacker crane 4 is used for identifying the article when storing or retrieving in the automatic warehouse 2, taking an inventory, and checking the other articles in stock. For example, when storing articles, it reads the bar code 21 of the article on the station with the bar code reader for a long distance 36, holds the article with the hand 33, and reads the bar code 22 with the bar code reader for a short distance to confirm. Similarly, when retrieving the article, it reads the bar code 21 of the articles in the racks 10,11 with the bar code reader for a long distance 36, confirms the article which is instructed to retrieve, and takes out the article with the hand 33, and reads the bar code 22 on the side face with the bar code reader for a short distance 37. In the case of confirmation of articles in stock, inventory, etc., it makes the stacker crane 4 travel along the racks 10,11 and reads the bar code 21 on the front face of the article with the bar code reader for a long distance 36 in each shelf address of the racks. Consequently, the bar codes of all the articles in the automatic warehouse 2 can be read with two units of bar code readers 36,37 fitted at the stacker crane 4.

Even if unusual event occurs to either bar code reader, or one of the bar codes 21,22 on the article 20 fails to be read, the other bar code can be read with the other bar code reader, for the stacker crane 4 is provided with two kinds of bar code readers 36,37. Therefore, the contents of the article in the automatic warehouse 2 may be identified without fail, and the process is never stopped due to an unidentified article etc. The bar code reader for a long distance 36 is capable of reading the bar code 21 of the article left in the racks 10,11, therefore it becomes extremely easy to take stock, and so on. The bar code 21 on the front face and the bar code 22 on the side face are placed in such a position that the both bar codes do not face each other, so the bar code of the other article is not read by mistake.

1. An automatic warehouse, provided with a conveyer which travels without restraint and has a hoisting table for transferring with an article and a mast moving up and down and supporting the hoisting table, wherein the hoisting table is equipped with a plurality of ID readers to read a plurality of ID codes attached to a different face of the article.

2. An automatic warehouse according to claim 1, comprising;
the ID code attached to a front face of an article and another face of the article; and
the hoisting table including an ID reader for a long distance to read the ID code on the front face of the article and an ID reader for a short distance to read the ID code on a face other than the front face of the article held by a transfer equipment installed on the hoisting table.

3. An automatic warehouse according to claim 2, wherein the ID reader for a short distance is provided and capable of reading the ID code attached on a side face of the article at the position where the article is taken in on the hoisting table side by the transfer equipment.

4. An automatic warehouse according to claim 2, wherein the transfer equipment is comprised of a flexible scalar arm and a hand linked to a front end of the scalar arm to hold the article.
